(19) United States
(12) Patent Application Publication
(10) Pub. No.: US 2026/0008347 A1
(43) Pub. Date: Jan. 8, 2026

(54) ELECTRONIC CONTROL APPARATUS FOR VEHICLE

(71) Applicants: TOYOTA JIDOSHA KABUSHIKI KAISHA, Toyota-shi (JP); Sumitomo Wiring Systems, Ltd., Yokkaichi (JP)

(72) Inventors: Naoya HIRAYAMA, Nagoya-shi (JP); Toshiya YAMADA, Yokkaichi-shi (JP)

(73) Assignees: TOYOTA JIDOSHA KABUSHIKI KAISHA, Toyota-shi (JP); Sumitomo Wiring Systems, Ltd., Yokkaichi (JP)

(21) Appl. No.: 19/223,288

(22) Filed: May 30, 2025

(30) Foreign Application Priority Data
Jul. 4, 2024 (JP) 2024-108169

(51) Int. Cl. B60L 3/00; B60R 16/023

(52) U.S. Cl. CPC B60L 3/0084; B60R 16/0231

(57) ABSTRACT

When a power-supply state is an off state and an abnormality condition is satisfied, an execution device executes a mask process of refraining from causing an electronic control apparatus to transition to a wake-up state based on a wake-up signal. The abnormality condition is to receive the wake-up signal a specified number of times or more.

### CROSS-REFERENCE TO RELATED APPLICATION

This application claims priority to Japanese Patent Application No. 2024-108169 filed on Jul. 4, 2024, incorporated herein by reference in its entirety.

### BACKGROUND

### 1. Technical Field

The present disclosure relates to an electronic control apparatus for a vehicle.

### 2. Description of Related Art

Japanese Unexamined Patent Application Publication No. 2016-22842 (JP 2016-22842 A) describes an electronic control apparatus mounted on a vehicle. The electronic control apparatus includes a terminal capable of receiving a wake-up signal. When the terminal receives a wake-up signal, an execution section of the electronic control apparatus performs a start process of causing the state of the electronic control apparatus to transition to a wake-up state from a sleep state.

The execution section performs a mask process when the time elapsed from the reception of the wake-up signal exceeds a predetermined time with no wake-up signal received after the reception and nobody is detected in the vehicle. In the mask process, the execution section disables the start process to avoid the wake-up state based on the wake-up signal.

### SUMMARY

The electronic control apparatus for the vehicle, however, operates by consuming electric power stored in a battery of the vehicle when the power-supply state of the vehicle is an off state. In the case, the operation of the electronic control apparatus decreases the electric power of the battery whether somebody is in the vehicle. The electronic control apparatus as described in JP 2016-22842 A therefore requests technology of performing a mask process by the execution section when the reception of a wake-up signal by the terminal is abnormal whether somebody is in the vehicle.

To solve the problem, the present disclosure is an electronic control apparatus for a vehicle. The electronic control apparatus is mounted on the vehicle and configured to operate by consuming electric power when the power-supply state of the vehicle is an off state. The electric power is stored in a battery when the power-supply state is an on state. The electronic control apparatus includes a terminal configured to receive a wake-up signal from the outside. The wake-up signal indicates a request to cause the electronic control apparatus to transition to a wake-up state from a sleep state. The electronic control apparatus is configured to consume the electric power more in the wake-up state than in the sleep state. The electronic control apparatus further includes an execution section configured to execute a start process of causing the electronic control apparatus to transition to the wake-up state based on the wake-up signal received by the terminal, and a mask process of refraining from causing the electronic control apparatus to transition to the wake-up state based on the wake-up signal when the power-supply state is the off state and the reception of the wake-up signal by the terminal satisfies an abnormality condition defined in advance. The abnormality condition is to receive the wake-up signal a specified number of times or more. The specified number of times is more than once and is defined in advance.

According to the configuration, the execution section executes a mask process in a case where the terminal receives a wake-up signal a specified number of times or more. The specified number of times is more than once and is defined in advance. That is, the execution section is capable of performing a mask process on the assumption that the reception of a wake-up signal by the terminal is abnormal depending on the number of times the terminal receives a wake-up signal.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram illustrating a vehicle;

FIG. 2 is a flowchart illustrating a series of processes including a start process; and

FIG. 3 is a flowchart illustrating a series of processes including a mask process.

### DETAILED DESCRIPTION OF EMBODIMENTS

Hereinafter, an embodiment of an electronic control apparatus for a vehicle will be described with reference to the drawings.

### Overview of Vehicle

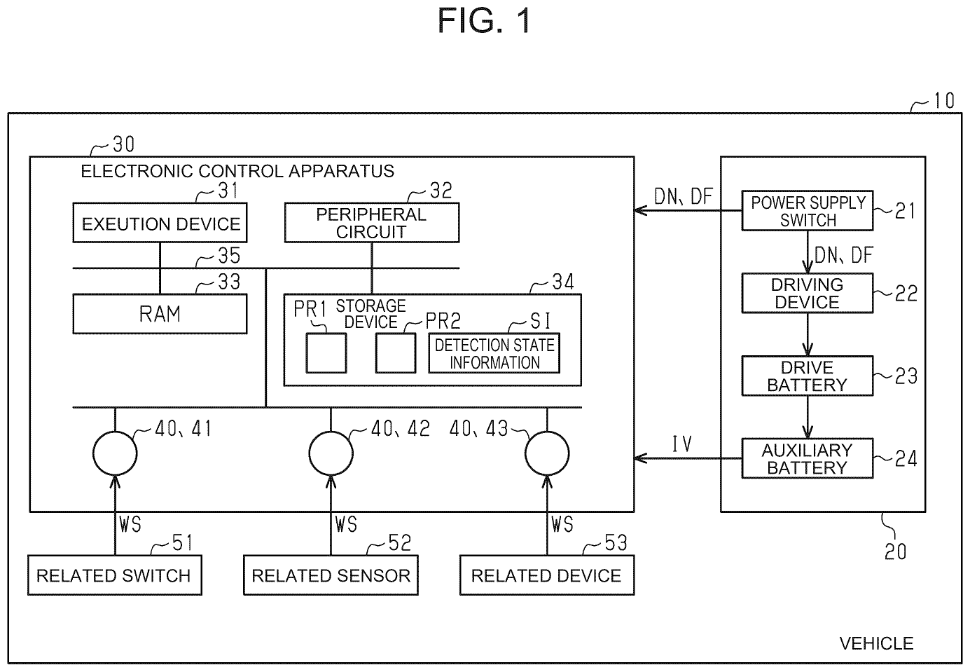

As illustrated in FIG. 1, a vehicle 10 includes an electric power supply system 20 and an electronic control apparatus 30. The electric power supply system 20 supplies the electronic control apparatus 30 with electric power.

The electric power supply system 20 includes a power supply switch 21, a driving device 22, a drive battery 23, and an auxiliary battery 24. The power supply switch 21 outputs an on request DN that causes the power-supply state of the vehicle 10 to transition to an on state. The power supply switch 21 outputs the on request DN to the electronic control apparatus 30. The power supply switch 21 outputs the on request DN to the driving device 22. In addition, the power supply switch 21 outputs an off request DF that causes the power-supply state of the vehicle 10 to transition to an off state. The power supply switch 21 outputs the off request DF to the electronic control apparatus 30. The power supply switch 21 outputs the off request DF to the driving device 22.

The driving device 22 is a device that drives the vehicle 10. The driving device 22 includes an engine and a traction motor. In the present embodiment, the vehicle 10 is a hybrid electric vehicle. When obtaining the off request DF from the power supply switch 21, the driving device 22 stops the driving. When obtaining the on request DN from the power supply switch 21, the driving device 22 starts the driving. When the driving device 22 is driven, the driving device 22 charges the drive battery 23.

The drive battery 23 is a high-voltage traction battery of the vehicle 10. The drive battery 23 supplies the motor of the driving device 22 with electric power. The drive battery 23 supplies the auxiliary battery 24 with electric power through an unillustrated converter when the power-supply state of the vehicle 10 is an on state.

The auxiliary battery 24 is a secondary battery. The auxiliary battery 24 is a low-voltage battery having a lower rated voltage than the rated voltage of the drive battery 23. The auxiliary battery 24 stores electric power supplied from the drive battery 23 when the power-supply state of the vehicle 10 is an on state. The auxiliary battery 24 supplies the electronic control apparatus 30 with electric power. In the present embodiment, the auxiliary battery 24 is a battery.

The electronic control apparatus 30 is mounted on the vehicle 10. For example, the electronic control apparatus 30 controls, for example, a room lamp provided to a door of the vehicle 10 such that the room lamp is turned on. The electronic control apparatus 30 therefore operates by using electric power supplied from the auxiliary battery 24 even when the power-supply state of the vehicle 10 is an off state.

The electronic control apparatus 30 obtains the on request DN and the off request DF from the power supply switch 21. In addition, the electronic control apparatus 30 calculates an input voltage IV that is a voltage input by the electric power supplied from the auxiliary battery 24.

The vehicle 10 includes a related switch 51, a related sensor 52, and a related device 53. The related switch 51, the related sensor 52, and the related device 53 each output a wake-up signal WS to the electronic control apparatus 30.

The related switch 51 is a switch related to the electronic control apparatus 30. The related switch 51 is, for example, a courtesy switch of a door of the vehicle 10. The courtesy switch detects the opening and closing state of the door of the vehicle 10. The related switch 51 outputs the wake-up signal WS to the electronic control apparatus 30. The wake-up signal WS is a signal indicating a request to cause the electronic control apparatus 30 to transition to a wake-up state from a sleep state. The sleep state is a state in which only the minimum functions defined in advance among functions that the electronic control apparatus 30 is capable of achieving are working. The minimum functions include, for example, a function of receiving the wake-up signal WS and a function of performing the related process. The wake-up state is a state in which the electronic control apparatus 30 is capable of attaining the main functions. The main functions of the electronic control apparatus 30 include turning on a room lamp provided to a door of the vehicle 10.

The related sensor 52 is a sensor related to the electronic control apparatus 30. The related sensor 52 is, for example, a seating sensor. The seating sensor is disposed at a driver's seat. It is detected that the driver's seat is occupied. The related sensor 52 outputs the wake-up signal WS to the electronic control apparatus 30.

The related device 53 is a device related to the electronic control apparatus 30. The related device 53 is, for example, a control device that controls a navigation device and an audio device of the vehicle 10. The related device 53 communicates with the electronic control apparatus 30 in compliance with a CAN standard or the like. The related device 53 outputs the wake-up signal WS to the electronic control apparatus 30.

### Electronic Control Apparatus

The electronic control apparatus 30 includes a plurality of terminals 40. The terminals 40 are each capable of receiving the wake-up signal WS from the outside of the electronic control apparatus 30. The terminals 40 each receive the wake-up signal WS to detect the wake-up signal WS. The terminals 40 include a first terminal 41, a second terminal 42, and a third terminal 43. The first terminal 41 receives the wake-up signal WS from the related switch 51. The second terminal 42 receives the wake-up signal WS from the related sensor 52. The third terminal 43 receives the wake-up signal WS from the related device 53.

The electronic control apparatus 30 includes an execution device 31 that is a CPU, a peripheral circuit 32, a RAM 33, a storage device 34, and a bus 35. The bus 35 communicably connects the execution device 31, the peripheral circuit 32, the RAM 33, the storage device 34, and the terminals 40 to each other.

The execution device 31 executes various programs stored in the storage device 34 to perform information processing. The peripheral circuit 32 includes a circuit that generates a clock signal which defines an internal operation, a power supply circuit, a reset circuit, and the like. The RAM 33 stores data generated by an operation of the execution device 31.

The storage device 34 stores a start program PR1 related to a start process of the electronic control apparatus 30 and a mask program PR2 related to a mask process. The start program PR1 and the mask program PR2 are executed by the execution device 31. The storage device 34 stores detection state information SI indicating the state of each of the terminals 40. The detection state information SI indicates that each of the terminals 40 is in an abnormal state or a normal state which is not the abnormal state. The abnormal state is a state in which reception by the terminal 40 satisfies an abnormality condition AC. The detection state information SI is updated by the execution device 31 to indicate that the terminal 40 for which the abnormality condition AC is determined to be satisfied is in the abnormal state. The abnormality condition AC is to receive the wake-up signal WS a specified number RC of times or more in a specified period RT defined in advance. The specified number RC of times is defined in advance. Details of the abnormality condition AC will be described below. It is to be noted that the execution device 31 is an execution section and the storage device 34 is a storage section in the present embodiment.

### Regarding Start Process

The execution device 31 is capable of causing the state of the electronic control apparatus 30 to transition to the wake-up state from the sleep state and transition to the sleep state from the wake-up state. In the wake-up state, the electronic control apparatus 30 operates by consuming more electric power supplied from the auxiliary battery 24 than in the sleep state.

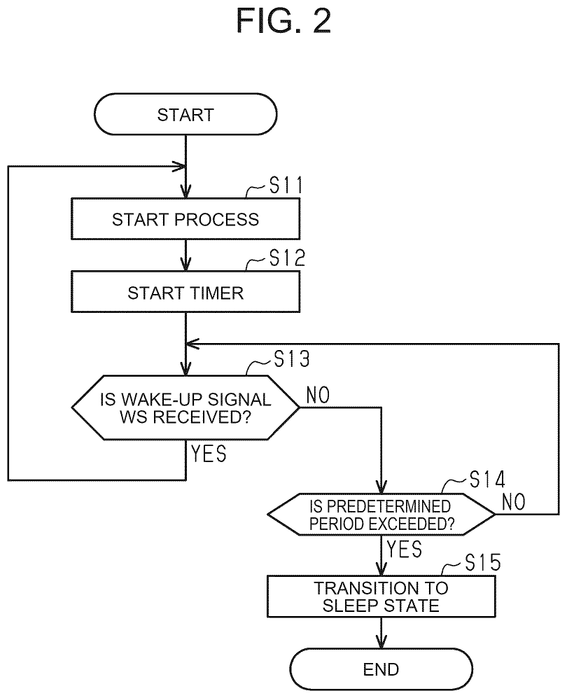

When the terminal 40 receives the wake-up signal WS with the electronic control apparatus 30 in the sleep state, the execution device 31 starts to execute the start program PR1. As illustrated in FIG. 2, the execution device 31 first performs the process of step S11 when starting to execute the start program PR1. In step S11, the execution device 31 performs a start process. In the start process, the execution device 31 causes the state of the electronic control apparatus 30 to transition to the wake-up state based on the wake-up signal WS received by the terminal 40. The start process hereby causes the state of the electronic control apparatus 30 to transition to the wake-up state from the sleep state when the state of the electronic control apparatus 30 is the sleep state. It is to be noted that the start process causes the state of the electronic control apparatus 30 to remain the wake-up state when the state of the electronic control apparatus 30 is the wake-up state. Thereafter, the execution device 31 advances the process to step S12.

In step S12, the execution device 31 starts a timer. Specifically, the execution device 31 starts measurement by a timer from zero. That is, the period indicated by the timer started through the process of step S12 is the period elapsed from the start process. Thereafter, the execution device 31 advances the process to step S13.

In step S13, the execution device 31 determines whether the terminal 40 receives the wake-up signal WS. When the terminal 40 receives the wake-up signal WS (S13: YES), the execution device 31 returns the process to step S11. In the case, the wake-up state is caused to continue through the process of step S11 and the timer is caused to start measurement from zero through the process of step S12.

In contrast, when the terminal 40 does not receive the wake-up signal WS (S13: NO), the execution device 31 advances the process to step S14. In step S14, the execution device 31 determines whether the period indicated by the timer exceeds a predetermined period defined in advance. When the period indicated by the timer does not exceed the predetermined period (S14: NO), the execution device 31 returns the process to step S13. In contrast, when the period indicated by the timer exceeds the predetermined period (S14: YES), the execution device 31 advances the process to step S15.

In step S15, the execution device 31 causes the state of the electronic control apparatus 30 to transition to the sleep state. That is, when not receiving the wake-up signal WS for the predetermined period, the execution device 31 causes the state of the electronic control apparatus 30 to transition to the sleep state. Thereafter, the execution device 31 ends the current series of processes. As described above, the execution device 31 causes the state of the electronic control apparatus 30 to transition to the wake-up state from the sleep state and transition to the sleep state from the wake-up state.

### Regarding Series of Processes Including Mask Process

The execution device 31 repeatedly executes the processes of the mask program PR2 for each of the terminals 40 in a specified cycle defined in advance. The processes of the mask program PR2 for the first terminal 41 will be described below.

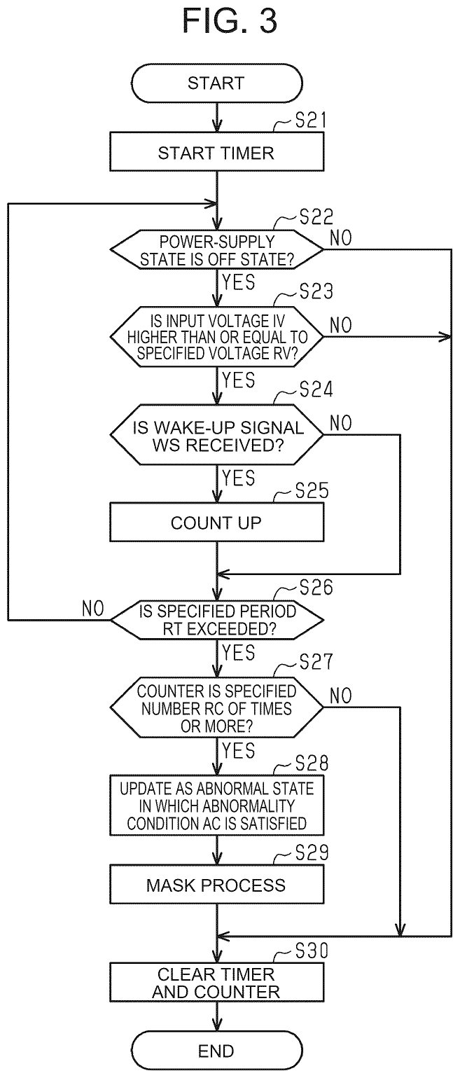

As illustrated in FIG. 3, the execution device 31 first performs the process of step S21 when starting to execute the mask program PR2. In step S21, the execution device 31 starts a timer. Measurement by the timer started through the process of step S21 is measurement for determining whether the specified period RT described below is exceeded. Thereafter, the execution device 31 advances the process to step S22.

In step S22, the execution device 31 determines whether the power-supply state of the vehicle 10 is an off state. Specifically, when the most recent request obtained from the power supply switch 21 is the on request DN, the execution device 31 determines that the power-supply state of the vehicle 10 is an on state. In contrast, when the most recent request obtained from the power supply switch 21 is the off request DF, the execution device 31 determines that the power-supply state of the vehicle 10 is an off state. When the power-supply state of the vehicle 10 is an off state (S22: YES), the execution device 31 advances the process to step S23.

In step S23, the execution device 31 determines whether the input voltage IV from the auxiliary battery 24 is higher than or equal to a specified voltage RV. The specified voltage RV is defined in advance by a test or a simulation as a minimum voltage necessary to normally count the wake-up signals WS described below and perform a mask process. When the input voltage IV is higher than or equal to the specified voltage RV (S23: YES), the execution device 31 advances the process to step S24.

In step S24, the execution device 31 determines whether the first terminal 41 receives the wake-up signal WS. When the first terminal 41 receives the wake-up signal WS (S24: YES), the execution device 31 advances the process to step S25.

In step S25, the execution device 31 counts up the counter. The number of times indicated by the counter indicates the number of times the wake-up signal WS is received in the specified period RT. Thereafter, the execution device 31 advances the process to step S26. In addition, when the first terminal 41 does not receive the wake-up signal WS (S24: NO), the execution device 31 does not perform the process of step S25 and advances the process to step S26.

In step S26, the execution device 31 determines whether the period indicated by the timer exceeds the specified period RT. The specified period RT is defined in advance by a test or a simulation as a period in which the reception of the wake-up signal WS is counted. When the period indicated by the timer does not exceed the specified period RT (S26: NO), the execution device 31 returns the process to step S22. In contrast, when the period indicated by the timer exceeds the specified period RT (S26: YES), the execution device 31 advances the process to step S27.

In step S27, it is determined whether the number of times indicated by the counter is the specified number RC of times or more. The specified number RC of times is the number of times that is more than once and is defined in advance. When the number of times indicated by the counter is the specified number RC of times or more (S27: YES), the execution device 31 determines that the reception of the wake-up signals WS by the first terminal 41 is in the abnormal state. That is, the abnormality condition AC is to receive the wake-up signal WS the specified number RC of times or more in the specified period RT. Thereafter, the execution device 31 advances the process to step S28.

In step S28, the execution device 31 updates the detection state information SI such that the detection state information SI indicates that the detection state of the terminal 40 which receives the wake-up signals WS is the abnormal state. Thereafter, the execution device 31 advances the process to step S29.

In step S29, the execution device 31 performs a mask process for the first terminal 41. In the mask process, the execution device 31 disables the received wake-up signals WS for the first terminal 41. In the state, even when the wake-up signal WS is input, the first terminal 41 does not detect the reception of the wake-up signal WS. As a result, the execution device 31 does not detect the reception by the first terminal 41 and thus disables a start process based on the wake-up signal WS received by the first terminal 41 subjected to the mask process. That is, the mask process is a process of disabling a start process based on the wake-up signal WS to refrain from causing the electronic control apparatus 30 to transition to the wake-up state based on the wake-up signal WS. Thereafter, the execution device 31 advances the process to step S30. In addition, when the number of times indicated by the counter is not the specified number RC of times or more (S27: NO), the execution device 31 does not perform the processes of step S28 and step S29 and advances the process to step S30.

In step S30, the execution device 31 clears the timer and the counter. Thereafter, the execution device 31 ends the current series of processes. It is to be noted that the execution device 31 causes the first terminal 41 subjected to a mask process to transition to a state in which the mask process is canceled when a period defined in advance passes. When the execution device 31 causes the first terminal 41 to transition to the state in which the mask process is canceled, the execution device 31 updates the detection state information SI such that the detection state information SI indicates that the first terminal 41 is in the normal state.

However, when the power-supply state is an on state (S22: NO), the execution device 31 advances the process to step S30. After performing the process of step S30, the execution device 31 ends the current series of processes. That is, when the power-supply state is an on state (S22: NO), the execution device 31 performs no mask process.

In addition, when the input voltage IV is lower than the specified voltage RV (S23: NO), the execution device 31 advances the process to step S30. After performing the process of step S30, the execution device 31 ends the current series of processes. That is, when the input voltage IV is lower than the specified voltage RV (S23: NO), the execution device 31 performs no mask process.

In addition, as described above, the execution device 31 executes the mask program PR2 for each of the terminals 40. The execution device 31 thus executes no mask process for the terminal 40 for which the abnormality condition AC is not satisfied, and executes a mask process for the terminal 40 for which the abnormality condition AC is satisfied.

### Workings of Embodiment

According to the embodiment, when the power-supply state of the vehicle 10 is an off state, the drive battery 23 supplies the auxiliary battery 24 with no electric power. Therefore, when the power supply of the vehicle 10 is in an off state, the electronic control apparatus 30 consumes electric power stored in the auxiliary battery 24 to decrease the electric power stored in the auxiliary battery 24. In contrast, when the electronic control apparatus 30 is in the sleep state, less electric power is consumed than in the wake-up state. The electric power stored in the auxiliary battery 24 is thus prevented from being excessively decreased.

When the electronic control apparatus 30 in the sleep state receives the wake-up signal WS, the electronic control apparatus 30 transitions to the wake-up state to consume more electric power than in the sleep state. The electric power stored in the auxiliary battery 24 is thus decreased more easily. In addition, when the electronic control apparatus 30 in the wake-up state keeps on receiving the wake-up signals WS, the electronic control apparatus 30 fails to transition to the sleep state to consume more electric power than in the sleep state. The electric power stored in the auxiliary battery 24 is thus decreased more easily.

### Effects of Embodiment

(1) In the embodiment, the execution device 31 performs a mask process when reception by the terminal 40 satisfies the abnormality condition AC. The mask process allows the electronic control apparatus 30 to prevent electric power from being excessively consumed because the electronic control apparatus 30 remains in the wake-up state. The abnormality condition AC is then to receive the wake-up signal WS the specified number RC of times or more. This allows the execution device 31 to perform a mask process when the reception of the wake-up signal WS by the terminal 40 is abnormal depending on the number of times the terminal 40 receives the wake-up signal WS. The execution device 31 is thus capable of executing a mask process whether any user is in the vehicle 10.

(2) According to the embodiment, the abnormality condition AC is to receive the wake-up signal WS the specified number RC of times or more in the specified period RT. This allows the execution device 31 to execute a mask process when the terminal 40 frequently receives the wake-up signal WS.

(3) According to the embodiment, the execution device 31 performs a mask process when the power-supply state of the vehicle 10 is an off state, the input voltage IV is higher than or equal to the specified voltage RV, and the reception of the wake-up signal WS by the terminal 40 satisfies the abnormality condition AC. In contrast, the execution device 31 performs no mask process when the input voltage IV is lower than the specified voltage RV. The electronic control apparatus 30 may fail to normally determine the abnormality condition AC and execute a mask process. It is therefore possible to prevent the electronic control apparatus 30 from unintentionally determining the abnormality condition AC and performing a mask process when the input voltage IV falls below the specified voltage RV.

(4) According to the embodiment, the execution device 31 executes the mask program PR2 for each of the terminals 40. The execution device 31 therefore executes no mask process for the terminal 40 for which the abnormality condition AC is not satisfied, and executes a mask process for the terminal 40 for which the abnormality condition AC is satisfied. It is therefore possible to prevent the mask processes for some of the terminals 40 from excessively restricting the other terminals 40.

(5) According to the embodiment, when performing a mask process, the execution device 31 updates the detection state information SI for the terminal 40 for which the mask process is performed such that the detection state information SI indicates the abnormal state. This allows the execution device 31 to grasp whether the state of the terminal 40 is the abnormal state by referring to the detection state information SI in the storage device 34.

### Other Embodiments

It is possible to modify and carry out the present embodiment as follows. It is possible to carry out the present embodiment and the following modification examples in combination as long as technological inconsistency is avoided.
The terminal 40 may receive the wake-up signal WS from the outside of the electronic control apparatus 30, and a source from which the wake-up signal WS is transmitted is not limited to the example of the embodiment.
The related switch 51, the related sensor 52, and the related device 53 may each output the wake-up signal WS to the electronic control apparatus 30. The relationship between the related switch 51 and the electronic control apparatus 30 may be that they are the source and destination of the wake-up signal WS. The same applies to the related sensor 52 and the related device 53 in the regard.
The execution device 31 may not need to perform a mask process for each of the terminals 40. For example, when the abnormality condition AC is satisfied for one of the terminals 40, mask processes may be performed for all of the terminals 40.
When the power-supply state of the vehicle 10 is an off state and the abnormality condition AC is satisfied, the execution device 31 may perform a mask process regardless of the input voltage IV. For example, the execution device 31 may omit the process of step S23.
The abnormality condition AC may be to receive the wake-up signal WS the specified number RC of times or more regardless of the specified period RT. For example, the execution device 31 may omit the processes of step S21 and step S26 and clear only the counter in step S30 when the power-supply state is an on state (S22: NO) and the input voltage IV is lower than the specified voltage RV (S23: NO). Furthermore, the execution device 31 may return the process to step S22 when the counter is less than the specified number RC of times in step S27. In the case, the execution device 31 is capable of performing a mask process on the assumption that the abnormality condition AC is satisfied if the terminal 40 receives the wake-up signal WS the specified number RC of times or more while the power-supply state remains an off state and the input voltage IV remains higher than or equal to the specified voltage RV.
A mask process is not limited to a process of disabling the reception of the wake-up signal WS as long as the mask process is a process of refraining from starting the electronic control apparatus 30 based on the wake-up signal WS. For example, the mask process may disable a start process based on the received wake-up signal WS or disable the output of the wake-up signal WS to the bus 35 by the terminal 40 after the wake-up signal is received.
A condition for canceling the applied mask process is not limited to the example of the embodiment. For example, the execution device 31 may cancel the applied mask process by the electronic control apparatus 30 receiving, from an external apparatus such as an inspection tool, a signal that requests the cancellation.
The storage device 34 may not need to store the detection state information SI. In addition, the execution device 31 may not need to update the detection state information SI.
The electronic control apparatus 30 may include the one terminal 40 alone.
A battery that supplies the electronic control apparatus 30 with electric power is not limited to the auxiliary battery 24. The battery may supply electric power stored when the power-supply state of the vehicle 10 is an on state to the electronic control apparatus 30 when the power-supply state of the vehicle 10 is an off state.
The driving device 22 may include an engine alone or may include a motor alone. That is, the vehicle 10 may be the vehicle 10 that is driven by an engine alone or may be the vehicle 10 that is driven by a motor alone.

What is claimed is:

1. An electronic control apparatus for a vehicle, the electronic control apparatus being mounted on the vehicle and configured to operate by consuming electric power when a power-supply state of the vehicle is an off state, the electric power being stored in a battery when the power-supply state is an on state, the electronic control apparatus comprising a terminal configured to receive a wake-up signal from outside, the wake-up signal indicating a request to cause the electronic control apparatus to transition to a wake-up state from a sleep state, the electronic control apparatus being configured to consume the electric power more in the wake-up state than in the sleep state, wherein
the electronic control apparatus further includes an execution section configured to execute
a start process of causing the electronic control apparatus to transition to the wake-up state based on the wake-up signal received by the terminal, and
a mask process of refraining from causing the electronic control apparatus to transition to the wake-up state based on the wake-up signal when the power-supply state is the off state and reception of the wake-up signal by the terminal satisfies an abnormality condition defined in advance, and
the abnormality condition is to receive the wake-up signal a specified number of times or more, the specified number of times being more than once and being defined in advance.

2. The electronic control apparatus for the vehicle according to claim 1, wherein the abnormality condition is to receive the wake-up signal the specified number of times or more in a specified period defined in advance.

3. The electronic control apparatus for the vehicle according to claim 1, wherein the execution section is configured to perform the mask process when the power-supply state is the off state, an input voltage to the electronic control apparatus is higher than or equal to a specified voltage defined in advance, and the abnormality condition is satisfied.

4. The electronic control apparatus for the vehicle according to claim 1, comprising a plurality of the terminals, wherein
the execution section is configured to refrain from executing the mask process for the terminal for which the abnormality condition is not satisfied and execute the mask process for the terminal for which the abnormality condition is satisfied.

5. The electronic control apparatus for the vehicle according to claim 4, further comprising a storage section configured to store detection state information indicating whether each of the terminals is in an abnormal state that is a state in which the reception of the wake-up signal by the terminal satisfies the abnormality condition, wherein
the execution section is configured to further execute an update, when performing the mask process, of the detection state information for the terminal for which the mask process is performed such that the detection state information indicates the abnormal state.
